(19) United States
(12) Patent Application Publication
(10) Pub. No.: US 2026/0264360 A1
(43) Pub. Date: Sep. 10, 2026

(54) ARRANGEMENT AND METHOD

(71) Applicant: BHS Corrugated Maschinen- und Anlagenbau GmbH, Weiherhammer (DE)

(72) Inventors: Florian Müller, Etzenricht (DE); Maximilian Rosemann, Vilseck (DE)

(21) Appl. No.: 18/875,563

(22) PCT Filed: Jul. 24, 2023
(86) PCT No.: PCT/EP2023/070452

§ 371 Date: Dec. 16, 2024

(30) Foreign Application Priority Data
Jul. 25, 2022 (DE) 10 2022 207 584.6

(51) Int. Cl. B31F 1/28; G01J 5/00

(52) U.S. Cl. CPC B31F 1/2818; B31F 1/2804; B31F 1/2836; G01J 5/0022; G01J 2005/0029

(57) ABSTRACT

An arrangement comprises a first unrolling device (3) for unrolling a first material web (20), a second unrolling device (4) for unrolling a second material web (26), and an apparatus (1) for producing a corrugated cardboard web which is laminated on one side from the material webs (20, 26). The apparatus (1) for producing a corrugated cardboard web which is laminated on one side has a corrugating device (41) for corrugating the first material web (20) with the formation of a corrugated web, a glue application device (45) for gluing the corrugated web (20), and a pressing device (51) for pressing the glued corrugated web (20) and second material web (26) onto one another with formation of a corrugated cardboard web (2) which is laminated on one side. Furthermore, the arrangement comprises a contactless temperature measuring device (57) for contactlessly measuring a temperature of the corrugated cardboard web (2) which is laminated on one side, and a processing unit (58) which is signal-connected to the temperature measuring device (57) and is capable of processing temperature signals from the temperature measuring device (57) with respect to the corrugated cardboard web (2) which is laminated on one side.

The present patent application claims the priority of German patent application DE 10 2022 207 584.6, the contents of which are incorporated herein by reference.

The invention relates to an arrangement which is in particular a component of a corrugated cardboard plant and is capable of producing a corrugated cardboard web which is laminated on one side. The invention further relates to a corresponding method.

It is generally known from prior public use that, in an arrangement comprising an apparatus for producing a corrugated cardboard web which is laminated on one side and comprising material web unrolling devices arranged upstream of the web, the positions of material webs are detected before the webs are glued together. However, until the glued connection is made, the material webs can still shrink or move in their transverse direction relative to each other. This can result in corrugated cardboard that is not of particularly high quality. Furthermore, it can happen that glue gets onto the corrugating rollers because glue dams of a glue application device are not positioned correctly. The apparatus for producing a corrugated cardboard web which is laminated on one side or the entire corrugated cardboard plant must then be stopped in order to clean the corrugating rollers.

The object of the invention is to overcome the disadvantages of the prior art. In particular, an arrangement is to be provided that allows a particularly efficient and sustainable production of corrugated cardboard. Furthermore, it should be possible to produce corrugated cardboard that is of extremely high quality. A corresponding method is also to be provided.

This object is achieved according to the invention by the features specified in independent claims 1 and 15. The core of the invention lies in the at least one contactless temperature measuring device which is assigned to the corrugated cardboard web which is laminated on one side and is capable of measuring or detecting the temperature of the corrugated cardboard web which is laminated on one side at least in regions, for example on one side or both sides, preferably at least on the edge, in a contactless or non-contact manner. It is expedient if the at least one contactless temperature measuring device is capable of measuring the temperature in at least one flat or linear region of the corrugated cardboard web which is laminated on one side. A (direct) contact between the temperature measuring device and the corrugated cardboard web which is laminated on one side is not required for temperature measurement. The temperature measuring device and the corrugated cardboard web which is laminated on one side are preferably arranged at a distance from each other during temperature measurement.

It is expedient if the at least one contactless temperature measuring device measures, at least in some regions, at least one surface temperature of the corrugated cardboard web which is laminated on one side. The contactless temperature measurement is preferably based on an evaluation of the radiation emitted by the corrugated cardboard web which is laminated on one side, in particular infrared radiation, or energy, in particular infrared energy, or the measurement thereof. The detected radiation or energy is translated or converted into a temperature signal, particularly an electrical one. Preferably, temperature distributions or temperature differences of the corrugated cardboard web which is laminated on one side are measurable or recognizable.

The at least one contactless temperature measuring device is preferably capable of measuring, preferably continuously, a current temperature of the adjacent corrugated cardboard web which is laminated on one side. It is preferably able to measure the temperature actively and/or passively. Active temperature measurement, for example, uses irradiation from at least one radiation source, such as an infrared source.

For example, the at least one contactless temperature measuring device comprises, in each case, a contactless temperature measuring device. This can be arranged in a fixed position, for example, or it can be displaced in a transverse or width direction of the corrugated cardboard web which is laminated on one side, i.e. perpendicular to its conveying or longitudinal direction.

Alternatively, the at least one contactless temperature measuring device comprises, for example, at least two, preferably exactly two, contactless temperature measuring devices which are arranged in a fixed position or can be displaced in the transverse direction or width direction of the corrugated cardboard web which is laminated on one side.

The at least one contactless temperature measuring device is arranged downstream of the pressing device in the conveying or transport direction of the corrugated cardboard web which is laminated on one side. It is expedient if it is arranged downstream of an outlet of the apparatus for producing a corrugated cardboard web which is laminated on one side. Conveniently, it is upstream of a bridge in the arrangement. It is expedient if the at least one contactless temperature measuring device is arranged upstream of or associated with an overhead transport apparatus of the arrangement.

The processing unit is preferably designed as an open-loop control and/or closed-loop control unit and is capable of receiving and processing the temperature signals. It is advantageously an electrical, preferably electronic, processing unit and is capable, for example, of checking the quality of the corrugated cardboard web which is laminated on one side.

The at least one contactless temperature measuring device and the processing unit are, for example, combined into one unit. Alternatively, they are designed or arranged separately from each other.

The bonding or gluing of the first and second material webs to each other takes place, for example, in the middle or precisely at the edges. Preferably, there is a center or edge alignment or control of the material webs.

The first unrolling device is preferably capable of unrolling an endless first material web. It is preferably designed as a splicing device.

The second unrolling device is advantageously capable of unrolling an endless second material web. It is advantageous if it is designed as a second splicing device.

It is expedient if the corrugating device has a first corrugating roller and a second corrugating roller arranged adjacent to the first corrugating roller, which form a corrugating gap for passing through and corrugating the first material web. The axes of rotation or longitudinal center axes of the corrugating rollers preferably run parallel to each other.

The glue application device preferably has a glue container and a glue application roller. It is expedient if the glue application roller forms a glue gap with the first corrugated roller for passing through and gluing the first material web or corrugated web. It is advantageous if the glue application roller applies the glue contained in the glue container to peaks of the corrugation of the corrugated web. The glue application device is advantageously arranged downstream of the corrugating device in the conveying direction of the corrugated web.

The pressing device is preferably designed as a pressing belt device, which advantageously has at least two pressing belt deflection rollers and an endless pressing belt guided around the pressing belt deflection rollers. The pressing belt preferably presses against the second material web, which in turn is pressed against the endless corrugated web provided with glue and in contact with the first corrugating roller. The pressing device is preferably arranged downstream of the corrugating device in the conveying direction of the corrugated web.

The arrangement is preferably part of a corrugated cardboard plant. A corrugated cardboard web which is laminated on both sides can preferably be produced from the corrugated cardboard web which is laminated on one side.

Further advantageous embodiments of the invention are specified in the dependent claims.

It is expedient if the thermal imaging device according to dependent claim 2 is equipped with an optical system. Thermography, particularly infrared thermography, is advantageously used to measure the temperature of the corrugated cardboard web which is laminated on one side. The contactless temperature measurement is preferably based on an optical evaluation of the radiation emitted by the corrugated cardboard web which is laminated on one side, in particular infrared radiation, or energy, in particular infrared energy, or the measurement thereof. By detecting the radiation or energy of the corrugated cardboard web which is laminated on one side, an electronic image is advantageously generated which represents a distribution of the temperature of the corrugated cardboard web which is laminated on one side. Thermal radiation from the corrugated cardboard web which is laminated on one side is recognizable or can be made visible. It is advantageous if the thermal imaging device comprises at least one photoreceiver or microbolometer or array. The arrangement preferably has a corresponding display, such as a screen, for displaying the temperature of the corrugated cardboard web which is laminated on one side.

The arrangement according to dependent claim 3 is particularly efficient. The at least one contactless temperature measuring device is preferably capable of detecting or measuring at least the at least one longitudinal edge region, in particular its temperature distribution. Its temperature distribution can advantageously be detected, made visible or determined by the at least one contactless temperature measuring device or processing unit. Preferably, the temperature distributions of at least the two longitudinal edge regions of the corrugated cardboard web which is laminated on one side can advantageously be detected, made visible or determined. A temperature distribution of a central region of the corrugated cardboard web which is laminated on one side can be detected or measured. Alternatively, no temperature measurement is taken there.

The embodiment according to dependent claim 4 allows, for example, a conclusion to be drawn about the positioning of the corrugated web relative to the second material web. The at least one longitudinal edge or side edge of the corrugated web, in particular its position or course, can preferably be detected or measured by the at least one contactless temperature measuring device when measuring the temperature of the corrugated cardboard web which is laminated on one side. Advantageously, both longitudinal edges of the corrugated web can be detected or measured by the at least one contactless temperature measuring device. Preferably, the at least one contactless temperature measuring device or processing unit is capable of detecting, determining or making visible at least one longitudinal edge of the corrugated web. The at least one longitudinal edge of the corrugated web has a temperature different from at least one adjacent region of the corrugated cardboard web which is laminated on one side.

The arrangement according to dependent claim 5 is particularly economical. The at least one side glue edge, in particular its position or course, can preferably be detected or measured by the at least one contactless temperature measuring device when measuring the temperature of the corrugated cardboard web which is laminated on one side. Advantageously, both side glue edges can be detected or measured by the at least one contactless temperature measuring device. It is expedient if the at least one contactless temperature measuring device or processing unit is capable of detecting, determining or making visible at least one side glue edge. The at least one side glue edge has a temperature different from at least one adjacent region of the corrugated cardboard web which is laminated on one side.

The arrangement according to dependent claim 6 results in a corrugated cardboard web which is laminated on one side or corrugated cardboard which is of particularly high quality. An arrangement or a course of the at least one circumferential groove can preferably be determined by measuring the temperature of the corrugated cardboard web which is laminated on one side. Preferably, arrangements or courses of several, advantageously of all, circumferential grooves can be determined. It is advantageous if the at least one circumferential groove can be detected, determined or made visible by the at least one contactless temperature measuring device or processing unit. The corrugated cardboard web which is laminated on one side has a temperature adjacent to the region of the corrugated cardboard web which is laminated on one side that runs over the at least one circumferential groove that is different from that of at least one adjacent region of the corrugated cardboard web which is laminated on one side.

The at least one circumferential groove is preferably designed as a suction groove. It is preferably designed as an annular groove. It is advantageous if the processing unit knows or is able to calculate the course or position of the at least one circumferential groove, in particular its position in relation to a longitudinal extent of the corrugating roller used. For example, the processing unit accesses a database or, for example, external data about the corrugating roller. An arrangement of longitudinal edges of the first material web at a distance from the at least one circumferential groove, in particular laterally or in the longitudinal direction of the corrugating roller, leads to a particularly high-quality corrugated cardboard web which is laminated on one side.

The embodiment according to dependent claim 7 also results in a particularly high-quality laminated corrugated cardboard web which is laminated on one side. In particular, the processing unit is able to check whether a correct position or target distance of the corrugated web from the at least one circumferential groove is maintained.

Due to the embodiment as per dependent claims 8 and 9, edge trimming of the corrugated cardboard web which is laminated on one side or waste can be reduced or avoided. This is particularly efficient and sustainable. The processing unit or the at least one contactless temperature measuring device is preferably capable of determining the at least one single-ply edge region when measuring the temperature of the corrugated cardboard web which is laminated on one side. In the single-ply edge region there is only the corrugated web or second material web. Outside the single-ply edge region, the corrugated cardboard web which is laminated on one side is two-ply.

The embodiment according to dependent claims 10 and 11 also leads to a particularly efficient and sustainable production of a corrugated cardboard web which is laminated on one side. The transverse positions of the material webs are preferably changeable relative to one another, in particular in the device for producing a corrugated cardboard web which is laminated on one side.

According to dependent claim 10, the first unrolling device is, for example, capable of influencing the first material web in such a way as to shift it or to deflect it in its transverse direction so that it is correspondingly displaced. A corresponding displacement, such as shifting or tilting, leads to a change in the course of the first material web in its transverse direction. It is expedient if a corresponding change in the transverse position of the first material web takes place at least in the device for producing a corrugated cardboard web which is laminated on one side and/or with respect to the second material web, for example in order to minimize the at least one single-ply edge region. Preferably, at least one device of the first unrolling device can be displaced accordingly. In particular, at least one receiving device of the first unrolling device can be shifted transversely from its basic position or neutral position and/or tilted or inclined. In the basic position, the first material web rolls off normally.

According to dependent claim 11, the second unrolling device is, for example, capable of influencing the second material web in such a way as to shift it or to deflect it in its transverse direction so that it is correspondingly displaced. A corresponding displacement, such as shifting or tilting, leads to a change in the course of the second material web in its transverse direction. It is expedient if a corresponding change in the transverse position of the second material web takes place at least in the device for producing a corrugated cardboard web which is laminated on one side and/or with respect to the second material web, for example in order to minimize the at least one single-ply edge region. Preferably, at least one device of the second unrolling device can be correspondingly displaced. In particular, at least one receiving device of the second unrolling device can be shifted transversely from its basic position or neutral position and/or tilted or inclined. In the basic position, the second material web rolls off normally.

The embodiment according to dependent claim 12 also allows a particularly economical and sustainable production of a corrugated cardboard web which is laminated on one side or of corrugated cardboard. It is expedient if the glue application device has at least one glue dam which can be displaced in the transverse direction of the corrugated web and is able to spatially limit the application of glue to the corrugated web, in particular to the outside laterally, or to spatially limit the width of the glue application. The at least one glue dam is preferably adaptable to the width or course of the corrugated web. Preferably, the glue application device has two glue dams. Each glue dam is preferably plate-shaped.

The at least one first transverse position detection device according to dependent claim 13 preferably operates contactlessly and advantageously continuously. It is expedient if it is designed as a light grid, sensor, camera, ultrasonic detection apparatus, infrared detection device or the like. It is preferably able to detect the current position or the course of the first material web in its transverse direction. This makes it possible to produce, extremely efficiently, a corrugated cardboard web which is laminated on one side which is also of particularly high quality.

The at least one second transverse position detection device according to dependent claim 14 preferably operates contactlessly and advantageously continuously. It is expedient if it is designed as a light grid, sensor, camera, ultrasonic detection apparatus, infrared detection apparatus or the like. It is preferably able to detect the current position or the course of the second material web in its transverse direction. This makes it possible to produce, extremely efficiently, a corrugated cardboard web which is laminated on one side which is also of particularly high quality.

The dependent claims also relate to preferred embodiments of the method according to independent claim 15.

The terms “arranged before”, “arranged after”, “upstream”, “downstream” or the like used here refer in particular to the conveying direction of the associated or assigned web.

The specified signal connections can be wired or wireless. Corresponding signals or information can be transmitted in this way.

Preferred embodiments of the invention are described below by way of example with reference to the accompanying drawings. In the figures:

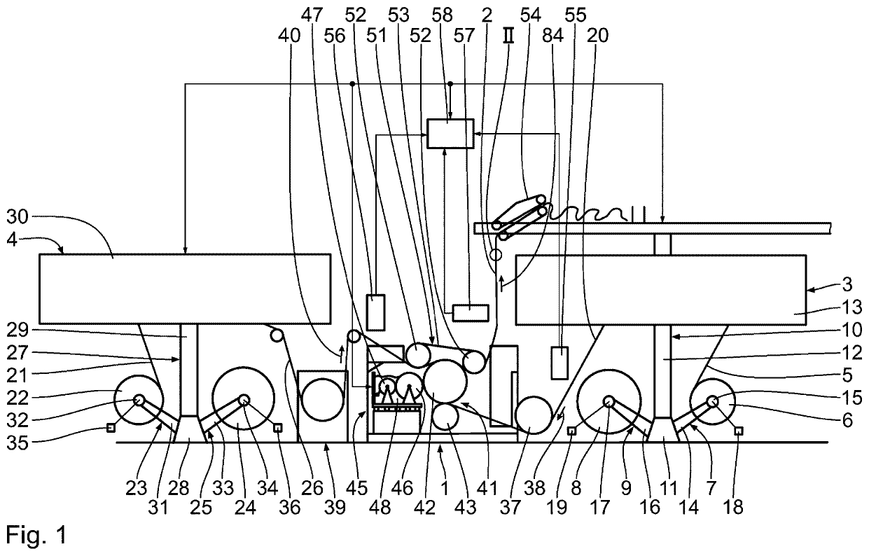

FIG. 1 is a simplified side view of an arrangement according to the invention,

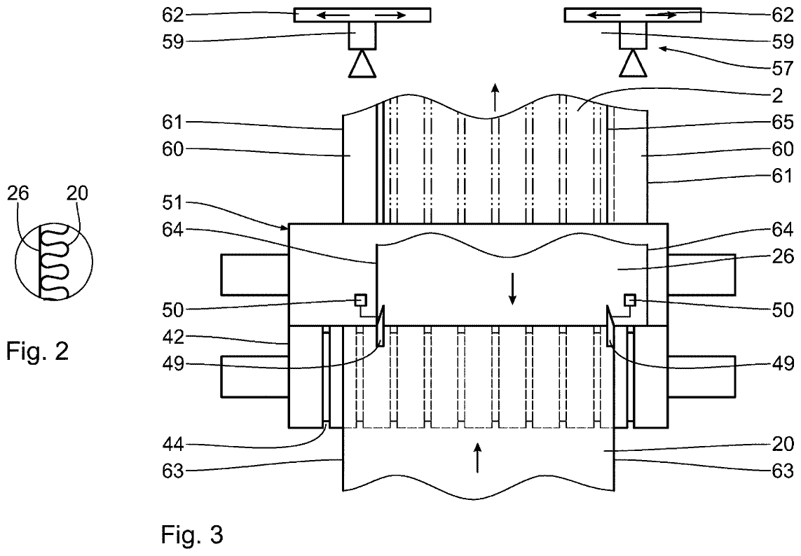

FIG. 2 shows the detail marked in FIG. 1,

FIG. 3 is a simplified partial view showing a pressing device and corrugating roller as well as glue dams of the arrangement shown in FIG. 1 together with the first and second material web and the corrugated cardboard web which is laminated on one side,

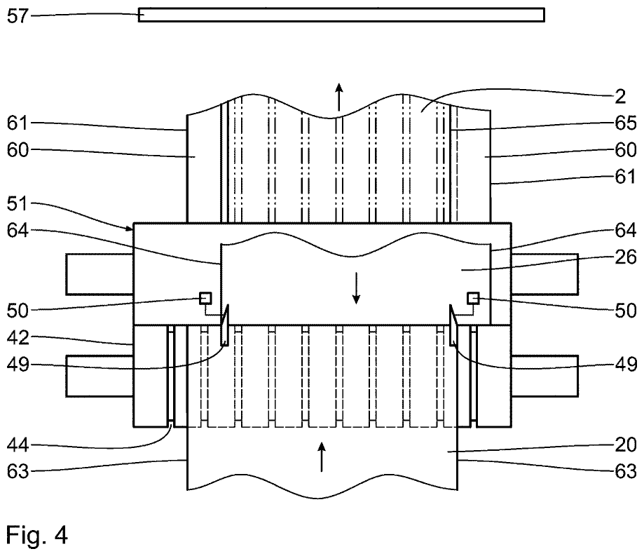

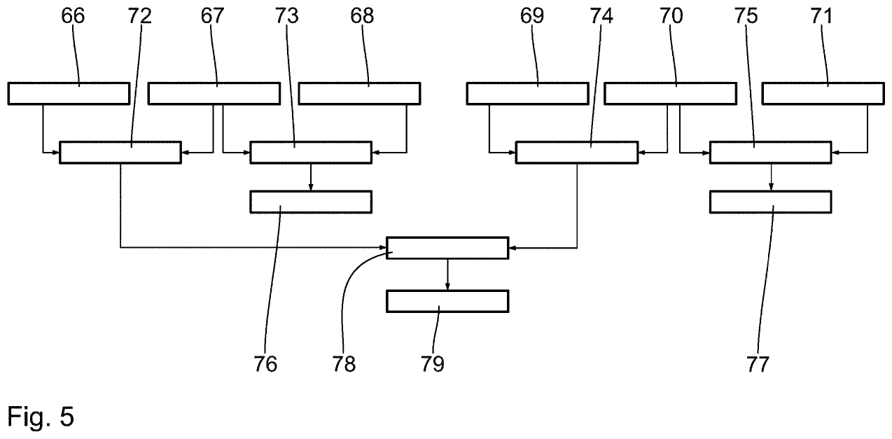

FIG. 4 shows a partial view corresponding to FIG. 3, illustrating an alternative embodiment of the invention,

FIG. 5 shows a first part of a flow chart relating to a change in a transverse position of a material web, and

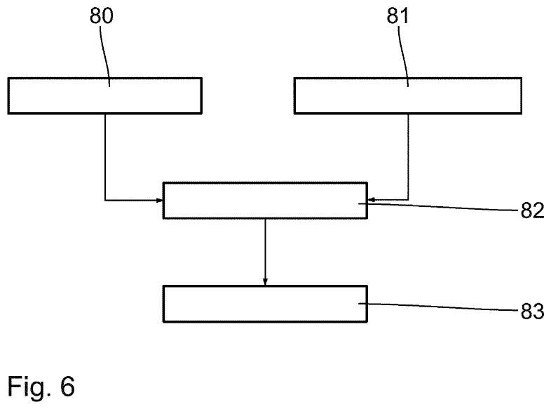

FIG. 6 shows a second part of the flow chart relating to the use of a transverse displacement value.

Referring first to FIG. 1, a corrugated cardboard plant (not shown in its entirety) comprises a device 1 for producing an endless corrugated cardboard web which is laminated on one side, which plant is capable of producing an endless corrugated cardboard web 2 which is laminated on one side.

A first splicing device 3 and a second splicing device 4 are arranged upstream of the device 1 for producing a corrugated cardboard web which is laminated on one side.

The first splicing device 3 is designed as an intermediate web splicing device. It comprises a first unrolling device 7 for unrolling an endless first intermediate web 5 from a first intermediate web roller 6 and a second unrolling device 9 for unrolling an endless second intermediate web from a second intermediate web roller 8.

The first splicing device 3 further comprises a base frame 10 with at least one base frame base 11, at least one base frame stand 12 and at least one base frame support 13. The at least one base frame base 11 is attached to a floor or substrate. The at least one base frame stand 12 is arranged on the at least one base frame base 11 and extends vertically or perpendicular to the floor. The at least one base frame support 13 is arranged at an end of the at least one base frame stand 12 opposite the at least one base frame base 11 and runs parallel to the floor.

The at least one base frame support 13 carries a splicer device of the first splicing device 3. By means of the splicer device, the endless first intermediate web 5 and the endless second intermediate web are connected to one another to provide an endless intermediate web 20. The endless first intermediate web 5 or the endless second intermediate web are guided by the respective intermediate web roller 6, 8 into the splicer device. The splicer device is preferably designed as a connecting and cutting device. The intermediate web 5, 20 forms a first material web. It has two intermediate web longitudinal edges or side edges 63 which run parallel to each other (FIG. 3).

The base frame 10 carries an elongate first support arrangement which extends horizontally and supports the first unrolling device 7. The first unrolling device 7 has two first support arms 14 which are arranged along the first support arrangement and each carry a first receiving part 15. The first receiving parts 15 are guided into a central opening of the first intermediate web roller 6. They engage the first intermediate web roller 6 from both end faces and form a first receiving device. A longitudinal center axis of the first intermediate web roller 6 then runs parallel to the first support arrangement.

The first support arms 14 are jointly and uniformly displaceable along the first support arrangement, which leads to a displacement of the first intermediate web roller 6 along its longitudinal center axis or of the endless first intermediate web 5 or endless intermediate web 20 rolled off therefrom in its transverse direction or width direction. Alternatively or additionally, they can be pivoted relative to one another about the first support arrangement, which makes possible a tilting of the first intermediate web roller 6 and thus a deflection of the endless first intermediate web 5 or endless intermediate web 20 in its transverse direction.

The base frame 10 also supports an elongate second support arrangement which extends horizontally and runs parallel to the first support arrangement. The second support arrangement supports the second unrolling device 9. The first and second unrolling devices 7, 9 are arranged opposite one another relative to the at least one base frame stand 12 or base frame base 11.

The second unrolling device 9 has two second support arms 16 which are arranged along the second support arrangement and each carry a second receiving part 17. The second receiving parts 17 are guided into a central opening of the second intermediate web roller 8. They engage the second intermediate web roller 8 from both end faces and form a second receiving device. A longitudinal center axis of the second intermediate web roller 8 then runs parallel to the second support arrangement.

The second support arms 16 are jointly and uniformly displaceable along the second support arrangement, which leads to a displacement of the second intermediate web roller 8 along its longitudinal center axis or of the endless second intermediate web or endless intermediate web 20 rolled off therefrom in its transverse direction or width direction. Alternatively or additionally, they can be pivoted relative to one another about the second support arrangement, which makes possible a tilting of the second intermediate web roller 8 and thus a deflection of the endless second intermediate web or endless intermediate web 20 in its transverse direction.

For the corresponding displacement of the first support arms 14, the first splicing device 3 has at least one corresponding first displacement unit 18, which comprises, for example, at least one electric drive, pneumatic drive or hydraulic drive.

For the corresponding displacement of the second support arms 16, the first splicing device 3 has at least one corresponding second displacement unit 19, which comprises, for example, at least one electric drive, pneumatic drive or hydraulic drive.

The second splicing device 4 is designed similarly to the first splicing device 3. This is embodied as a cover-web web splicing device and comprises a third unrolling device 23 for unrolling an endless first cover web 21 from a first cover web roller 22 and a fourth unrolling device 25 for unrolling an endless second cover web from a second cover web roller 24.

The second splicing device 4 further comprises a base frame 27 with at least one base frame base 28, at least one base frame stand 29 and at least one base frame support 30. The at least one base frame base 28 is attached to the floor or substrate. The at least one base frame stand 29 is arranged on the at least one base frame base 28 and extends vertically or perpendicular to the floor. The at least one base frame support 30 is arranged at an end of the at least one base frame stand 29 opposite the at least one base frame base 28 and runs parallel to the floor.

The at least one base frame support 30 carries a splicer device of the second splicing device 4. By means of the splicer device, the endless first cover web 21 and the endless second cover web are connected to one another to provide an endless cover web 26. The endless first cover web 21 and the endless second cover web are fed by the respective cover web rollers 22 and 24 into the splicer device. The splicer device is preferably designed as a connecting and cutting device. The cover web 21, 26 forms a second material web. It has two cover-web longitudinal edges or side edges 64 which run parallel to each other (FIG. 3).

The base frame 27 carries an elongate third support arrangement which extends horizontally and supports the third unrolling device 23. The third unrolling device 23 has two first support arms 31 which are arranged along the third support arrangement and each carry a first receiving part 32. The first receiving parts 32 are guided into a central opening of the first cover web roller 22. They engage the first cover web roller 22 from both end faces and form a first receiving device. A longitudinal center axis of the first cover web roller 22 then runs parallel to the third support arrangement.

The first support arms 31 are jointly and uniformly displaceable along the third support arrangement, which leads to a displacement of the first cover web roller 22 along its longitudinal center axis or of the endless first cover web 21 or endless cover web 26 rolled off therefrom in its transverse direction or width direction. Alternatively or additionally, they can be pivoted relative to one another about the third support arrangement, which makes possible a tilting of the first cover web roller 22 and thus a deflection of the endless first cover web 21 or endless cover web 26 in its transverse direction.

The base frame 27 also supports an elongate fourth support arrangement which extends horizontally and runs parallel to the third support arrangement. The fourth support arrangement supports the fourth unrolling device 25. The third unrolling device 23 and the fourth unrolling device 25 are arranged opposite one another relative to the at least one base frame stand 29 or base frame base 28.

The fourth unrolling device 25 has two second support arms 33 which are arranged along the fourth support arrangement and each carry a second receiving part 34. The second receiving parts 34 are guided into a central opening of the second cover web roller 24. They engage the second cover web roller 24 from both end faces and form a second receiving device. A longitudinal center axis of the second cover web roller 24 runs parallel to the fourth support arrangement.

The second support arms 33 are jointly and uniformly displaceable along the fourth support arrangement, which leads to a displacement of the second cover web roller 24 along its longitudinal center axis and of the endless second cover web or endless cover web 26 unrolled therefrom in its transverse direction or width direction. The second support arms 33 can alternatively or additionally be pivoted relative to one another about the fourth support arrangement, which makes possible a tilting of the second cover web roller 24 and thus a deflection of the endless second cover web or endless cover web 26.

For the corresponding displacement of the first support arms 31, the second splicing device 4 has at least one corresponding third displacement unit 35, which comprises, for example, at least one electric drive, pneumatic drive or hydraulic drive.

For the corresponding displacement of the second support arms 33, the second splicing device 4 has at least one corresponding fourth displacement unit 36, which comprises, for example, at least one electric drive, pneumatic drive or hydraulic drive.

The endless intermediate web 20 is fed via a deflection roller 37 in a first conveying direction 38 to the device 1 for producing a corrugated cardboard web which is laminated on one side, while the endless cover web 26 is fed via a heating device 39 in a second conveying direction 40 to the device 1 for producing a corrugated cardboard web which is laminated on one side.

The device 1 for producing a corrugated cardboard web which is laminated on one side comprises a corrugating device 41 with a first corrugating roller 42 and a second corrugating roller 43 for producing an endless corrugated web having a corrugation from the endless intermediate web 20. The corrugating rollers 42, 43 are arranged adjacently to each other. They form a corrugating gap for guiding through and corrugating the endless intermediate web 20. The corrugating rollers 42, 43 are mounted so that they can rotate or can be driven in rotation. The axes of rotation of the corrugating rollers 42, 43 run parallel to each other and preferably one above the other.

As shown in FIG. 3, the first corrugating roller 42 has a plurality of circumferential grooves 44 which are arranged spaced apart from one another along the first corrugating roller 42 and extend around the longitudinal center axis of the first corrugating roller 42. They are open to the outside and endless. The circumferential grooves 44 run in planes extending perpendicular to the longitudinal center axis of the first corrugating roller 42 and are in fluidic connection with at least one vacuum source so that the endless intermediate web 20 is held on the first corrugating roller 42 and lies cleanly in recesses of its corrugation.

In order to connect the endless cover web 26 to the endless corrugated intermediate web or corrugated web 20 in order to form the corrugated cardboard web 2 which is laminated on one side, the device 1 for producing a corrugated cardboard web which is laminated on one side has a glue application device 45, which advantageously comprises a glue application roller 46, a glue metering roller 47 and a glue container 48. For guiding the endless corrugated intermediate web or corrugated web 20 through and gluing it, the glue application roller 46 forms a gluing gap with the first corrugating roller 42. The glue in the glue container 48 is applied to peaks of the corrugation of the endless corrugated web 20 via the glue application roller 46. The glue metering roller 47 is assigned to the glue application roller 46 and serves to form a uniform glue layer on the glue application roller 46.

The glue application device 45 also has two glue dams 49 (FIG. 3), which, during use, lie close to the glue application roller 46 and the glue metering roller 47. Each glue dam 49 preferably has a corresponding sealing edge. The glue dams 49 run perpendicular to the glue application roller 46 and the glue metering roller 47.

The glue dams 49 are arranged along the glue application roller 46 and the glue metering roller 47 at a distance from one another and are displaceable, in particular shiftable. They can be displaced relative to each other or together as a unit. They serve to laterally spatially limit the glue in the glue container 48 and to adjust a gluing region of the endless corrugated intermediate web 20 in its transverse direction. In order to apply glue to different width or transverse regions of the endless corrugated intermediate web 20, the glue dams 49 can be displaced in the transverse direction of the endless corrugated intermediate web 20. By displacing the glue dams 49, a glue width on the endless corrugated web 20 or a distance of a glue region on the endless corrugated web 20 to its longitudinal edges can be adjusted. The mutual position and/or spacing of the glue dams 49 can be adapted to the endless corrugated web 20 to be glued. Each glue dam 49 is assigned a fifth displacement unit 50 for its displacement (FIG. 3). The displacement units 50 can be operated independently of one another.

After the glue has been applied to the endless corrugated intermediate web 20, each glue dam 49 forms a glue edge 65 which extends adjacently to and parallel to a longitudinal edge 61 of the corrugated cardboard web 2 which is laminated on one side. Each glue edge 65 is located, for example, between the endless intermediate web 20 and the endless cover web 26. It is thus covered and forms a lateral border of the gluing region. Instead of the vacuum source in fluidic connection with the circumferential grooves 44, the glue application device 45 can be subject to overpressure so that in particular the endless intermediate web 20 is held on the first corrugating roller 42 and lies cleanly in the recesses of its corrugation. A source of overpressure is then present. What is essential is a pressure gradient or a pressure difference, which can be achieved by an appropriate pressure gradient or pressure difference source.

The smooth endless cover web 26 is then joined to the endless corrugated web 20 provided with glue from the glue container 48 in the device 1 for producing a corrugated cardboard web which is laminated on one side. In order to press the endless cover web 26 against the glued endless corrugated web 20, which in turn is in regions in contact with the first corrugating roller 42, the device 1 for producing a corrugated cardboard web which is laminated on one side has a pressing device 51, which is designed as a pressing belt device or pressing belt module. The pressing device 51 is arranged above the first corrugating roller 42. It has at least two pressing belt deflection rollers 52 arranged at a distance from one another and an endless pressing belt 53 which is guided around the pressing belt deflection rollers 52. The first corrugating roller 42 partially engages from below in a space between the pressing belt deflection rollers 52, whereby the pressing belt 53 is deflected by the first corrugating roller 42. The pressing belt 53 presses against the endless cover web 26, which in turn is pressed against the endless corrugated web 20 provided with glue and contacting the first corrugating roller 42 so as to form the corrugated cardboard web 2 which is laminated on one side.

The corrugated cardboard web 2 which is laminated on one side is mostly two-ply. It consists of the endless cover web 26 and the endless corrugated web 20 (FIG. 2). In the region in which the endless cover web 26 and corrugated web 20 overlap each other, the corrugated cardboard web 2 which is laminated on one side is two-ply. Laterally at its outside, i.e. on the edge, it is (in each case) single-ply. As shown in FIG. 3, in the corrugated cardboard web 2 which is laminated on one side, one longitudinal edge 61 is formed by an intermediate web longitudinal edge 63 and the other longitudinal edge 61 is formed by a cover web longitudinal edge 64. In the corrugated cardboard web 2 which is laminated on one side, the longitudinal edges 61, intermediate web longitudinal edges 63, cover web longitudinal edges 64 and glue edges 65 run parallel to each other and along the corrugated cardboard web 2 which is laminated on one side. The corrugated cardboard web 2 which is laminated on one side may have one or two single-ply edge regions.

In order to temporarily store and buffer the corrugated cardboard web 2 which is laminated on one side, said web is fed via an overhead transport device 54 to a storage device of the corrugated cardboard plant, where it forms loops.

The corrugated cardboard plant also comprises a lamination web splicing device (not shown) which is capable of producing a lamination web, in particular an endless one.

The corrugated cardboard plant also includes a gluing unit (not shown) that applies glue to the endless corrugated web 20 of the corrugated cardboard web 2 which is laminated on one side.

Downstream of the gluing unit, the corrugated cardboard plant has a heating-pressing device (not shown) which comprises a horizontally extending heating table. Adjacent to the heating table there is an endless pressing belt guided around guide rollers. A pressing gap is formed between the pressing belt and the heating table, through which the corrugated cardboard web 2 which is laminated on one side and the laminating web are guided to form a preferably endless three-ply corrugated cardboard web.

If the corrugated cardboard plant comprises more than one device 1 for producing a corrugated cardboard web which is laminated on one side, a double-sided laminated corrugated cardboard web can be produced which has more than three layers, such as five or seven layers.

The endless intermediate web 20 is assigned a first transverse position detection device 55, which is arranged between the first splicing device 3 and the device 1 for producing a corrugated cardboard web which is laminated on one side, in particular between the first splicing device 3 and the deflection roller 37. The first transverse position detection device 55 is thus arranged downstream of the first splicing device 3 or its outlet or output in the first conveying direction 38 of the endless intermediate web 20. It is arranged upstream of the corrugating device 41 in the first conveying direction 38 of the endless intermediate web 20. The first transverse position detection device 55 is arranged, for example, above the endless intermediate web 20.

The endless cover web 26 is assigned a second transverse position detection device 56, which is arranged between the second splicing device 4 and the pressing device 51. The second transverse position detection device 56 is thus arranged downstream of the second splicing device 4 or its outlet or output in the second conveying direction 40 of the endless cover web 26. It is arranged upstream of the pressing device 51 in the second conveying direction 40 of the endless cover web 26. The second transverse position detection device 56 is arranged, for example, above the endless cover web 26.

The corrugated cardboard web 2 which is laminated on one side is assigned a temperature measuring device 57 which is arranged between the device 1 for producing a corrugated cardboard web which is laminated on one side and a bridge carrying the storage device. The temperature measuring device 57 is thus arranged downstream of the pressing device 51 or an output thereof in a conveying direction 84 of the corrugated cardboard web 2 which is laminated on one side. For example, it is arranged adjacent to the output of the pressing device 51.

The temperature measuring device 57 is designed as a contactless temperature measuring device. It is arranged at a distance from, but adjacent to, the corrugated cardboard web 2 which is laminated on one side. The endless cover web 26 of the corrugated cardboard web 2 which is laminated on one side faces the temperature measuring device 57. The endless corrugated web 20 of the corrugated cardboard web 2 which is laminated on one side is therefore facing away from the temperature measuring device 57. The temperature measuring device 57 is thus located on the side of the endless cover web 26. Alternatively, the temperature measuring device 57 is arranged on the side of the endless corrugated web 20.

The arrangement also comprises an electronic processing unit 58.

The first transverse position detection device 55 and the second transverse position detection device 56 are at least from time to time in signal connection with the processing unit 58. The processing unit 58 receives electrical signals from the transverse position detection devices 55, 56 which relate to the respective current transverse position of the endless intermediate web 20 or endless cover web 26 at the respective transverse position detection device 55 or 56.

The temperature measuring device 57 is also in signal connection with the processing unit 58, at least from time to time. The processing unit 58 receives electrical signals from the temperature measuring device 57 which relate to the current temperature of the corrugated cardboard web 2 which is laminated on one side at the temperature measuring device 57.

The processing unit 58 is at least from time to time in signal connection with the first splicing device 3. In particular, it is at least in signal connection from time to time with the first displacement unit 18 or the second displacement unit 19. The processing unit 58 is in particular capable of operating, in particular controlling, the first displacement unit 18 or the second displacement unit 19 if necessary.

The processing unit 58 is also at least in signal connection from time to time with the second splicing device 4. In particular, it is at least in signal connection from time to time with the third displacement unit 35 or the fourth displacement unit 36. The processing unit 58 is in particular capable of operating, in particular controlling, the third displacement unit 35 or fourth displacement unit 36 if necessary.

The processing unit 58 is also at least in signal connection from time to time with the glue application device 45. In particular, it is at least in signal connection from time to time with the fifth displacement units 50. It is able to actuate, in particular to control, the fifth displacement units 50 if necessary.

The signal connections are wireless or wired connections.

The device 1 for producing a corrugated cardboard web which is laminated on one side produces the corrugated cardboard web 2 which is laminated on one side. This is used to produce a corrugated cardboard web which is laminated on both sides. The temperature measuring device 57 detects, for example periodically or continuously, two longitudinal edge regions 60 of the corrugated cardboard web 2 which is laminated on one side. It measures their temperature. The transverse position detection devices 55, 56 detect or measure, for example periodically or continuously, the respective current transverse position of the endless intermediate web 20 or endless cover web 26.

The processing unit 58 evaluates the transverse positions of the endless intermediate web 20 and of the endless cover web 26 relative to each other, as detected by the transverse position detection devices 55, 56. To determine a transverse deviation or a lateral offset of the endless intermediate web 20 and endless cover web 26 to each other, i.e. perpendicular to their conveying direction 38 or 40, it calculates, for example, a difference between a center of the endless intermediate web 20 and the endless cover web 26 with respect to the transverse direction. The processing unit 58 is, for example, able to detect a lateral offset of the endless intermediate web 20 and the endless cover web 26 relative to one another.

If the processing unit 58 detects a deviation of an actual value from a target value, a corresponding transverse displacement of the endless intermediate web 20 and/or endless cover web 26 takes place. For example, the transverse position of the endless intermediate web 20 and/or endless cover web 26 is adjusted to a center. Alternatively, they can be exactly adjusted to edges.

As shown in FIG. 3, the temperature measuring device 57 comprises two separate temperature measuring devices 59, each of which is designed as a thermal imaging camera. The temperature measuring devices 59 are identically designed and arranged at a distance from one another in the transverse direction of the corrugated cardboard web 2 which is laminated on one side. Each temperature measuring device 59 is capable of detecting a longitudinal edge region 60 of the corrugated cardboard web 2 which is laminated on one side or measuring its temperature. Each longitudinal edge region 60 adjoins an outer longitudinal edge 61 of the corrugated cardboard web 2 which is laminated on one side and extends adjacent thereto. The two longitudinal edges 61 and longitudinal edge regions 60 extend in the conveying direction 84 of the corrugated cardboard web 2 which is laminated on one side. Between these there is a central region of the corrugated cardboard web 2 which is laminated on one side.

Each temperature measuring device 59 is carried by a support device 62 which extends in a transverse direction or width direction of the corrugated cardboard web 2 which is laminated on one side, i.e. perpendicular to its conveying direction 84. Each temperature measuring device 59 is displaceable or movable along the associated support device 62. It is expedient if each temperature measuring device 59 moves back and forth along the associated support device 62 for the temperature measurement. For example, each temperature measuring device 59 is assigned its own support device 62. Alternatively, the temperature measuring devices 59 share a common support device 62. The temperature measuring devices 59 can, for example, be moved independently of one another or in a synchronized manner.

As shown in FIG. 4, according to an alternative embodiment, instead of the displaceable temperature measuring devices 59, a stationary temperature measuring device 57 is provided which extends in the transverse direction of the corrugated cardboard web 2 which is laminated on one side and which is capable of detecting at least the longitudinal edge regions 60 of the corrugated cardboard web 2 which is laminated on one side. For example, a single stationary temperature measuring device 57 is provided for this purpose, which extends over the entire width of the corrugated cardboard web 2 which is laminated on one side. Alternatively, for example, two stationary temperature measuring devices 59 are provided, which are arranged at a distance from one another in the transverse direction of the corrugated cardboard web 2 which is laminated on one side. Each temperature measuring device 59 is arranged such that it is able to detect a longitudinal edge region 60.

The operation of the arrangement is described in greater detail below with reference to FIG. 5.

The temperature measuring device 57 detects the two longitudinal edge regions 60. It measures their temperature.

In a step 66, the second transverse position detection apparatus 56 and/or temperature measuring device 57 detects a first cover web longitudinal edge 64 of the endless cover web 26. The first cover web longitudinal edge 64 extends, for example, on the drive side in relation to the arrangement. In particular, its transverse or width position is measured or determined.

In a step 67, the first transverse position detection device 55 and/or temperature measuring device 57 detects a first intermediate web longitudinal edge 63 of the endless intermediate web 20. The first intermediate web longitudinal edge 63 extends on the same side of the corrugated cardboard web 2 which is laminated on one side as the first cover web longitudinal edge 64, for example on the drive side. In particular, its transverse or width position is measured or determined. In the case of the corrugated cardboard web 2 which is laminated on one side, the first intermediate web longitudinal edge 63 and the first cover web longitudinal edge 64 run adjacently to one another.

In a step 68, the temperature measuring device 57 detects a first glue edge 65 in a first longitudinal edge region 60, which extends on the same side of the corrugated cardboard web 2 which is laminated on one side as the first cover web longitudinal edge 64, for example on the drive side. In particular, its transverse or width position is measured or determined. In the case of the corrugated cardboard web 2 which is laminated on one side, the first glue edge 65 runs adjacently to the first intermediate web longitudinal edge 63 or the first cover web longitudinal edge 64.

In a step 69, the second transverse position detection device and/or temperature measuring device 57 detects a second cover web longitudinal edge 64 of the endless cover web 26. The second cover web longitudinal edge 64 runs, for example, on the operator side with respect to the arrangement. It extends opposite the first cover web longitudinal edge 64. In particular, its transverse or width position is measured or determined.

In a step 70, the first transverse position detection device 55 and/or temperature measuring device 57 detects a second intermediate web longitudinal edge 63 of the endless intermediate web 20. In particular, their transverse or width position is measured or determined. The second intermediate web longitudinal edge 63 extends on the same side of the corrugated cardboard web 2 which is laminated on one side as the second cover web longitudinal edge 64, for example on the operator side. In the case of the corrugated cardboard web 2 which is laminated on one side, the second intermediate web longitudinal edge 63 and the second cover web longitudinal edge 64 run adjacently to one another.

In a step 71, the temperature measuring device 57 detects a second glue edge 65 in a second longitudinal edge region 60, which extends on the same side of the corrugated cardboard web 2 which is laminated on one side as the second cover web longitudinal edge 64, for example on the operator side. In particular, its transverse or width position is measured or determined. In the case of the corrugated cardboard web 2 which is laminated on one side, the second glue edge 65 runs adjacently to the second intermediate web longitudinal edge 63 or the second cover web longitudinal edge 64.

Steps 66 to 71 are carried out simultaneously or (slightly) staggered in time.

In a step 72, the processing unit 58 calculates a difference between the transverse position of the first cover web longitudinal edge 64 detected in step 66 and of the transverse position of the first intermediate web longitudinal edge 63 detected in step 67.

In a step 73, the processing unit 58 calculates a difference between the transverse position of the first intermediate web longitudinal edge 63 detected in step 67 and of the transverse position of the first glue edge 65 detected in step 68.

In a step 74, the processing unit 58 calculates a difference between the transverse position of the second cover web longitudinal edge 64 detected in step 69 and of the transverse position of the second intermediate web longitudinal edge 63 detected in step 70.

In a step 75, the processing unit 58 calculates a difference between the transverse position of the second intermediate web longitudinal edge 63 detected in step 70 and of the transverse position of the second glue edge 65 detected in step 71.

Steps 72 to 75 can be carried out simultaneously or (slightly) staggered in time.

In a step 76, the glue dam 49, which creates the first glue edge 65, is adjusted accordingly, if necessary on the basis of the difference calculated in step 73. For this purpose, the processing unit 58 correspondingly controls the associated fifth displacement unit 50. The glue dam 49 is either moved away from the other glue dam 49 or towards it.

In a step 77, the glue dam 49, which creates the second glue edge 65, is correspondingly adjusted, if necessary on the basis of the difference calculated in step 75. For this purpose, the processing unit 58 correspondingly controls the associated displacement unit 50. The glue dam 49 is either moved away from the other glue dam 49 or towards it.

In a step 78, the processing unit 58 calculates a difference between the difference calculated in step 72 and the difference calculated in step 74.

In a step 79, a corresponding adjustment of the endless cover web 26 takes place, if necessary based on the difference calculated in step 78. For this purpose, the processing unit 58 correspondingly controls the third or fourth displacement unit 35, 36. For example, the currently active or unrolled cover web roller 22, 24 is axially displaced and/or tilted. The second splicing device 4 then rolls off the endless cover web 21 or endless cover web 26 according to a target specification, preferably in such a way that it can be connected in the device 1 for producing a corrugated cardboard web which is laminated on one side, for example substantially congruently with the endless intermediate web 20 or centrally with it in relation to its transverse direction. The processing unit 58 adjusts, in particular controls, the transverse position of the endless cover web 26 according to the transverse position of the endless intermediate web 20. Subsequent edge trimming of a corrugated cardboard web which is laminated on both sides can preferably be minimized or made completely unnecessary.

Alternatively or additionally, the first or second displacement unit 18, 19 is actuated correspondingly, in particular to minimize or eliminate edge trimming.

Alternatively, the transverse position of the endless intermediate web 20 is controlled according to the transverse position of the endless cover web 26.

As shown in FIG. 6, in a step 80, a course of a first circumferential groove 44 or of the circumferential grooves 44 on the corrugated cardboard web 2 which is laminated on one side is detected by means of the temperature measuring device 57. In particular, their transverse position or width position in relation to the first corrugating roller 42 is measured or determined.

In a step 81, the processing unit 58 calculates a transverse position of the first circumferential groove 44 or of the circumferential grooves 44. The transverse position of the first circumferential groove 44 or of the circumferential grooves 44 may also be known in another way.

In a step 82, the processing unit 58 calculates a difference between the transverse position of the first circumferential groove 44 or of the circumferential grooves 44 detected in step 80 and the transverse position of the first circumferential groove 44 or of the circumferential grooves 44 calculated in step 81.

In a step 83, the difference determined in step 82 is used as an offset or transverse displacement value for a transverse displacement of the endless intermediate web 20 relative to the first circumferential groove 44 or to the circumferential grooves 44. The offset value can be determined automatically. The processing unit 58 preferably actuates the first splicing device 3 in such a way that at least one intermediate web longitudinal edge 63, preferably both intermediate web longitudinal edges 63, is/are arranged laterally offset to the circumferential grooves 44 of the first corrugating roller 42 or offset to the circumferential grooves 44 along the first corrugating roller 42.

Fully automated bonding and gluing can thus be ensured.

1. An arrangement comprising:
a) a first unrolling device for unrolling a first material web,
b) a second unrolling device for unrolling a second material web,
c) an apparatus for producing a corrugated cardboard web which is laminated on one side from the first material web and the second material web, wherein the apparatus for producing a corrugated cardboard web which is laminated on one side comprises
i) a corrugating device for corrugating the first material web to form a corrugated web,
ii) a glue application device for gluing the corrugated web, and
iii) a pressing device for pressing the glued corrugated web and the second material web against each other to form a corrugated cardboard web which is laminated on one side,
d) at least one contactless temperature measuring device for contactlessly measuring a temperature of the corrugated cardboard web which is laminated on one side, and
e) a processing unit which is at least from time to time in signal connection with the at least one contactless temperature measuring device and is capable of processing temperature signals from the at least one contactless temperature measuring device to the corrugated cardboard web which is laminated on one side.

2. The arrangement according to claim 1, wherein the at least one contactless temperature measuring device is designed as a thermal imaging device.

3. The arrangement according to claim 1 wherein, a temperature distribution of at least one longitudinal edge region of the corrugated cardboard web which is laminated on one side can be determined.

4. The arrangement according to claim 1, wherein at least one longitudinal edge of the corrugated web can be determined.

5. The arrangement according to claim 1, wherein preceding at least one side glue edge of a glue application produced by the glue application device can be determined.

6. The arrangement according to claim 1, wherein a course of at least one circumferential groove of at least one corrugating roller of the corrugating device can be determined.

7. The arrangement according to claim 6, wherein the processing unit is capable of checking a position of the corrugated web relative to at least one circumferential groove.

8. The arrangement according to claim 1, wherein at least one single-ply edge region of the corrugated cardboard web which is laminated on one side can be determined.

9. The arrangement according to claim 8, wherein the processing unit is capable of effecting a minimization of the at least one single-ply edge region of the corrugated cardboard web which is laminated on one side in a transverse direction of the corrugated cardboard web which is laminated on one side.

10. The arrangement according to claim 1, wherein the processing unit is at least from time to time in signal connection with the first unrolling device and is capable of effecting a change in a transverse position of the first material web.

11. The arrangement according to claim 1, wherein the processing unit is at least from time to time in signal connection with the second unrolling device and is capable of effecting a change in a transverse position of the second material web.

12. The arrangement according to claim 1, wherein claim 1, the processing unit is at least from time to time in signal connection with the glue application device and is capable of effecting a change in the application of glue to the corrugated web in a transverse direction of the corrugated web.

13. The arrangement according to claim 1, further comprising at least one first transverse position detection apparatus arranged upstream of the corrugating device and at least from time to time in signal connection with the processing unit for detecting a transverse position of the first material web.

14. The arrangement according to claim 13, further comprising at least one second transverse position detection apparatus arranged upstream of the pressing device and at least from time to time in signal connection with the processing unit for detecting a transverse position of the second material web.

15. A method comprising the steps of:
(a) unrolling a first material web from a first unrolling device,
(b) unrolling a second material web from a second unrolling device,
(c) producing a corrugated cardboard web which is laminated on one side by means of an apparatus for producing a corrugated cardboard web which is laminated on one side, which apparatus has
(i) a corrugating device for corrugating the first material web in order to form a corrugated web,
(ii) a glue application device for gluing the corrugated web, and
(iii) a pressing device for pressing the glued corrugated web and the second material web against each other to form a corrugated cardboard web which is laminated on one side,
(d) contactlessly measuring a temperature of the corrugated cardboard web which is laminated on one side by means of at least one contactless temperature measuring device, and
(e) processing temperature signals from the at least one contactless temperature measuring device to the corrugated cardboard web which is laminated on one side doing so by means of a processing unit which is at least from time to time in signal connection with the at least one contactless temperature measuring device.
